(19) United States
(12) Patent Application Publication
(10) Pub. No.: US 2022/0305572 A1
(43) Pub. Date: Sep. 29, 2022

(54) Boring Tool With Deburring Assembly

(71) Applicant: APEX BRANDS, INC., Apex, NC (US)

(72) Inventors: Brian Pigott, St. Catharines (CA); Alain Goulet, St. Catharines (CA); Bill McMaster, Ontario (CA)

(21) Appl. No.: 17/706,984

(22) Filed: Mar. 29, 2022

Related U.S. Application Data
(60) Provisional application No. 63/167,430, filed on Mar. 29, 2021.

(51) Int. Cl. B23B 51/10

(52) U.S. Cl. CPC B23B 51/101

(57) ABSTRACT

A cutting tool may include a shank having a drive end for interfacing with a powered driver, a body portion extending operably coupled to and extending away from the shank, a cutting portion extending from the body portion and sharing an axis with the shank and the body portion, the cutting portion including a plurality of cutting edges, and a deburring assembly operably coupled to the cutting portion or the body portion. The deburring assembly may be configured to be fully insertable into a hole cut by the cutting tool.

### TECHNICAL FIELD

Example embodiments generally relate to drilling or boring devices such as drill bits or other tools for forming cylindrical holes in a base material. In particular, example embodiments relate to drill bits or similar devices that incorporate a deburring assembly therein.

### BACKGROUND

Boring or reaming tools, such as drill bits, often have a drive end that includes a conventional interface for receiving drive energy from a powered driving device (e.g., a drill). The drive end may have a standard sized hex head or another conventional drive end geometry that enables the powered driving device to impart rotational force on the boring tool. The boring tool may also have a cutting end at which location a cutting point and/or cutting edges may be formed. By providing rotational energy to the drive end, the cutting end may bore a hole in the material or workpiece on which the boring tool is being used.

Although boring tools have been around for a very long time, and remain extremely useful components to many tool kits, they do have some commonly occurring issues. For example, the use of boring tools on a workpiece or surface can often form a burr. A burr is typically found at the entrance or exit of a hole, and takes the form of a rough edge or even as a ridge of excess material around the periphery of the entrance or exit o the hole. Burrs can be unsightly for some applications, but may actually leave a sharp ridge of material that can interfere with the ability of fasteners or other adjacent components to properly interface with the workpiece or surface. Burrs may also increase the likelihood of fatigue stress or corrosion, or otherwise interfere with lubrication or proper component fitting, in some cases.

Based on the possibility that each of the issues mentioned above (and perhaps others as well) may occur when a burr is formed, many manufacturers find it necessary to ensure that burrs are removed via a process called “deburring.” Deburring can be done a number of ways including manually, mechanically, electrochemically or thermally. However, the process of deburring in any of these forms can add significantly to the time and/or cost of manufacturing. Accordingly, it may be desirable to provide a better way of deburring.

### BRIEF SUMMARY OF SOME EXAMPLES

Some example embodiments may enable the provision of a cutting tool having a deburring capability. The cutting tool may include a shank having a drive end for interfacing with a powered driver, a body portion extending operably coupled to and extending away from the shank, a cutting portion extending from the body portion and sharing an axis with the shank and the body portion, the cutting portion including a plurality of cutting edges, and a deburring assembly operably coupled to the cutting portion or the body portion. The deburring assembly may be configured to be fully insertable into a hole cut by the cutting tool.

In another example embodiment, a drill bit with deburring capability may be provided. The drill bit may include a shank having a drive end for interfacing with a powered driver, a body portion extending operably coupled to and extending away from the shank, a cutting portion extending from the body portion and sharing an axis with the shank and the body portion where the cutting portion includes a plurality of cutting edges, and a deburring assembly disposed in a slot formed in the body portion. The deburring assembly may be removable and replaceable.

In another example embodiment, a drill bit with deburring capability may be provided. The drill bit may include a shank having a drive end for interfacing with a powered driver, a body portion extending operably coupled to and extending away from the shank, a cutting portion extending from the body portion and sharing an axis with the shank and the body portion where the cutting portion includes a plurality of cutting edges, and a deburring assembly disposed in a slot formed in the cutting portion. The deburring assembly may be removable and replaceable.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a drill bit according to an example embodiment;

FIG. 2, which is defined by FIGS. 2A and 2B, illustrates two different perspective views of a cutting portion of the drill bit according to an example embodiment;

FIG. 3 illustrates a deburring assembly removed from the cutting portion according to an example embodiment;

FIG. 4 illustrates a cross section view through the deburring assembly taken along line A-A′ of FIG. 1 according to an example embodiment;

FIG. 5 illustrates a perspective view of a drill bit capable of deburring at a shallow cutting depth according to an example embodiment;

FIG. 6 shows a perspective view of a cutting portion having a deburring assembly therein according to an example embodiment;

FIG. 7 illustrates a partially exploded view of the deburring assembly removed from the cutting portion according to an example embodiment;

FIG. 8 illustrates a cross section view through the deburring assembly taken along line B-B′ of FIG. 5 according to an example embodiment;

FIG. 9 illustrates a perspective view of a drill bit having deburring assemblies in both the cutting portion and the body portion according to an example embodiment; and

FIG. 10, which is defined by FIGS. 10A, 10B and 10C, illustrates deburring in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a boring tool (e.g., a drill bit) with a deburring assembly. In an example embodiment, the boring tool (which will be described as a drill bit hereinafter to illustrate one example) may be constructed in such a way as to integrate a plurality of brush filaments into the body or cutting portion of the drill bit to act as the deburring assembly. The brush filaments may be relatively easily integrated into a slot that passes radially though the body and/or cutting portion of the drill bit. Moreover, the brush filaments may be removable and replaceable. Thus, a deburring operation may be automatically performed for exit and/or entrance holes formed by the drill bit without adding additional cycle time or equipment costs. Some structures that can employ example embodiments will now be described below by way of example and not limitation.

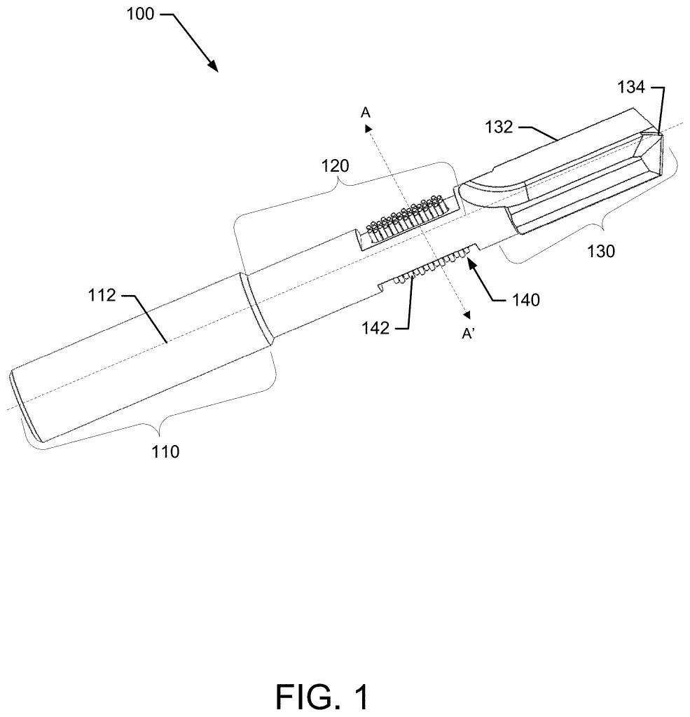

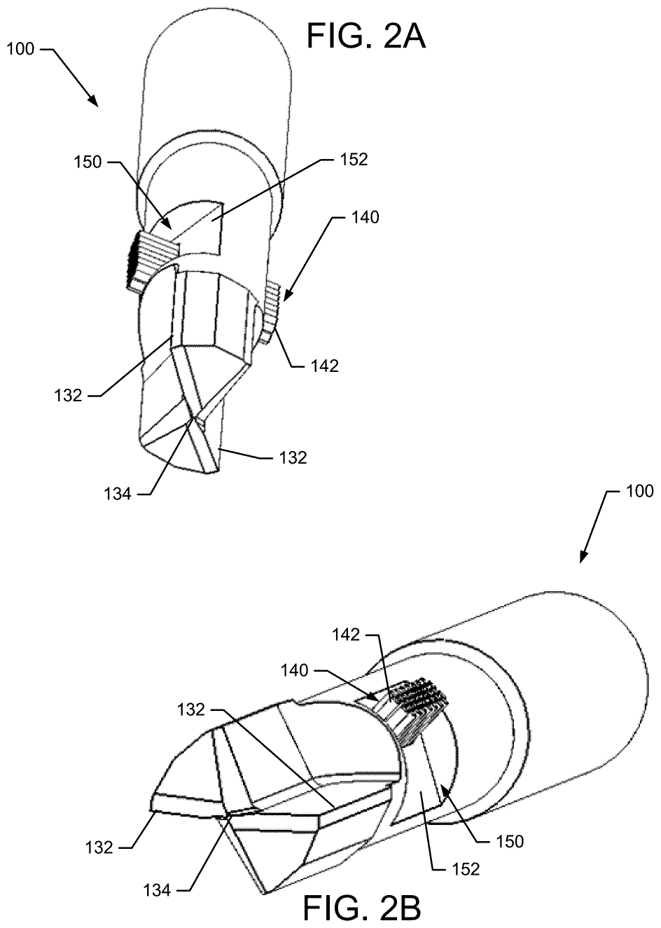

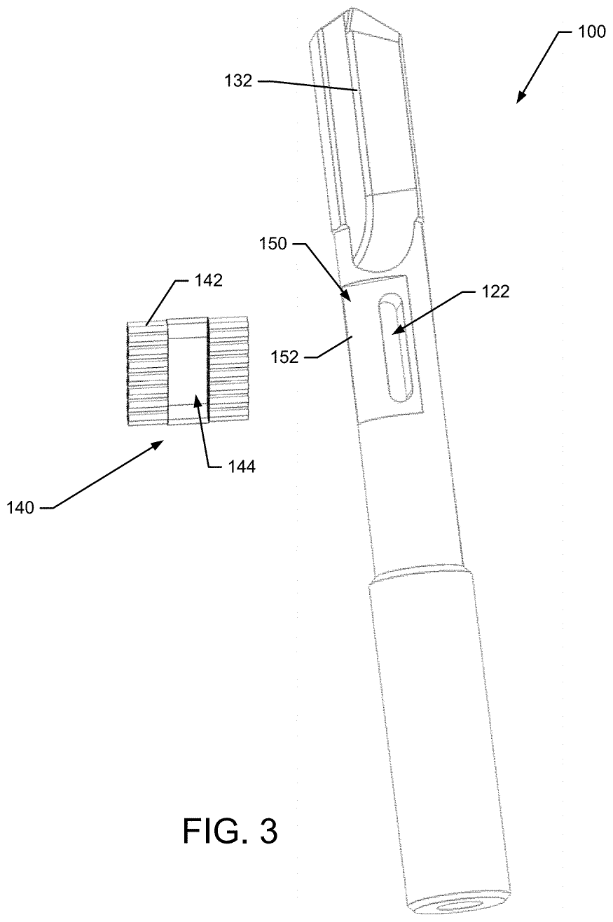

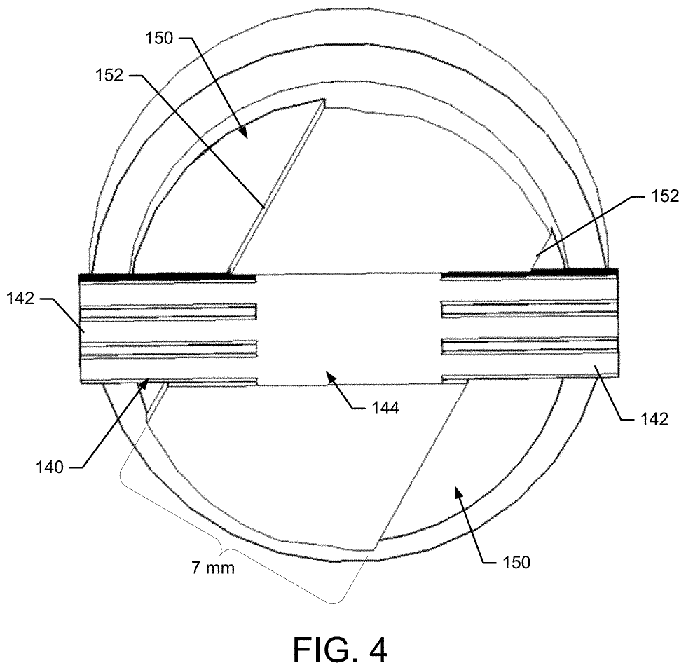

FIG. 1 illustrates a perspective view of a drill bit 100 according to an example embodiment, as one example of a boring tool. As can be seen in FIG. 1, the drill bit 100 includes a shank 110 at a drive end thereof, a body portion 120 extending away from the shank 110, and a cutting portion 130 at a cutting end opposite the drive end. The shank 110, the body portion 120 and the cutting portion 130 all share a common axis 112 that extends longitudinally through a middle of the drill bit 100. FIG. 2, which is defined by FIGS. 2A and 2B, illustrates two different perspective views of the cutting portion 130 according to an example embodiment showing a deburring assembly 140 in the body portion 120 of the drill bit 100. Meanwhile, FIG. 3 illustrates the deburring assembly 140 removed from the cutting portion and FIG. 4 illustrates a cross section view through the deburring assembly 140 taken along line A-A′ of FIG. 1.

Referring now to FIGS. 1-4, the drill bit 100 may include a slot 122 formed in the body portion 120. The slot 122 may be a channel that is formed to extend entirely through the body portion 120 in a direction substantially perpendicular to the axis 112 of the drill bit 100. The slot 122 may extend through the axis 112, perpendicular thereto, but may also extend longitudinally for a selected distance. In this regard, a length of the slot 122 (i.e., in a direction parallel to the axis 112 of the drill bit 100) may be substantially larger than a width of the slot 122. In some cases, the length may be about five times greater than the width, but other relationships may be defined in alternative embodiments. For example, if the width of the slot 122 is about 3 mm (i.e., 0.12 inches), then the length of the slot 122 may be about 15 mm (i.e., about 0.59 inches).

The deburring assembly 140 may fit into and extend out of opposing sides of the slot 122. In an example embodiment, the deburring assembly 140 may be defined by a plurality of brush filaments 142. The brush filaments 142 may, in some cases, be made of materials selected to have a hardness sufficient to effectively remove burrs for the material being drilled. In this regard, for example, the brush filaments 142 may be plastic material impregnated with 600 grit aluminum oxide in some cases. However, other materials (e.g., diamond impregnated filaments) may be used in other alternative embodiments.

The brush filaments 142 may be bundled together, and an adhesion agent (e.g., epoxy 144) may be used to retain the brush filaments 142 together as the deburring assembly 140. The epoxy 144 may also bind the brush filaments 142 inside the slot 122 and thereby retain the deburring assembly 140 in the slot 122. The number of brush filaments 142 employed may depend on the side of the slot 122, and the diameter of the brush filaments 142. In some cases, the brush filaments 142 may each have a diameter of about 0.012 inches. Meanwhile, a length of the brush filaments 142 may be greater than a diameter of the body portion 120. In some cases, the length of the brush filaments 142 may be 3% to 50% larger than the diameter of the body portion 120. Thus, for example, the diameter of the body portion 130 of the example of FIGS. 1-4 is about 12 mm (i.e., about 0.47 inches) and therefore the brush filaments 142 may range from about 12.4 mm to about 18 mm. In the pictured example, the brush filaments 142 may have a length of about 14.5 mm (i.e., 0.571 inches).

In order to accommodate the brush filaments 142 without causing binding, the brush filaments 142 may be enabled to bend into a recessed portion 150 that may be formed in lateral sides of the body portion 120 proximate to the slots 122. The recessed portion 150 may include a base surface 152 that is tangential to a circle having a radius defined by the distance from the axis 112 of the drill bit 100 to the base surface 152. In some cases, the brush filaments 142 may extend normal (or perpendicular) to the base surface 152. However, in other examples (such as that which is shown in FIG. 2), the brush filaments 142 may extend at an angle other than 90 degrees from the base surface 152 (e.g., an acute angle). Thus, the brush filaments 142 may either be centrally located within the recessed portion 150, or may be off center within the recessed portion 150 (as shown in the example of FIG. 2). Particularly for longer brush filaments 142, providing the brush filaments 142 off center within the recessed portion 150 may create more space in which the brush filaments 142 may flex or bend and avoid any possibility of binding within the hole drilled by the drill bit 100. Meanwhile, a distance between the base surfaces 152 on opposite sides of the body portion 120 may be about 7 mm, and the base surfaces 152 may be parallel to each other.

The cutting portion 130 may include a plurality of cutting edges 132 and a cutting point 134. Although the cutting edges 132 of this example extend substantially linearly along a line that is parallel to the axis 112 of the drill bit 100, other arrangements are also possible. In this regard, for example, the cutting edges 132 may be curved or even helical in alternative embodiments.

As can be appreciated from the descriptions above, the cutting point 134 may be engaged with a surface or workpiece that is to have a hole bored or drilled therein, and the drill bit 100 may be powered to transmit rotational forces to the drill bit 100. The cutting point 134 and the cutting edges 132 may then combine to bore a cylindrically shaped hole in the surface or workpiece. In some examples, the cutting edges 132 may have a length of about 13 mm, and may define a slightly larger diameter (between cutting edges 132 on opposing sides of the drill bit 100) than the diameter of the body portion 120. For example, if the body portion 120 has a diameter of about 12 mm, then the diameter defined between the cutting edges 132 may be about 13 mm in some embodiments. The cutting portion 130 may therefore bore a hole that extends deeper than the length of the cutting edges 132, and the body portion 120 may begin to follow the cutting portion 130 into the hole being drilled. When the deburring assembly 140 reaches the entrance (and any applicable exit encountered as well) of the hole being drilled, the brush filaments 142 will operate abrasively on the entrance and will deburr the entrance (and exit, if applicable). Thus, the deburring assembly 140 may work in both the insertion and withdrawal directions to conduct deburring.

In an example embodiment in which the drill bit 100 is made as a carbide bit, the material used to form the drill bit 100 may be pre-formed, and then the slot 122 may be machined or formed therein before sintering. After sintering, the carbine bit may be hardened with the slot 122 formed therein. The epoxy 144 may then be placed around the bundle of brush filaments 142 and the deburring assembly 140 may be placed in the slot 122. When the epoxy 144 cures, the deburring assembly 140 may be rigidly retained in the drill bit 100. To the extent the deburring assembly 140 becomes worn and needs to be replaced, the body portion 120 may be heated until the epoxy 144 fails. The old brush filaments may then be removed along with the heated epoxy from the slot 122. The slot 122 may be cleaned of any remnants or residue, and then a new deburring assembly 140 may be provided in the slot 122. The new deburring assembly 140 may be the same type as the one that was removed, or may be of a different type (i.e., having different characteristics with respect to filament material, length or diameter).

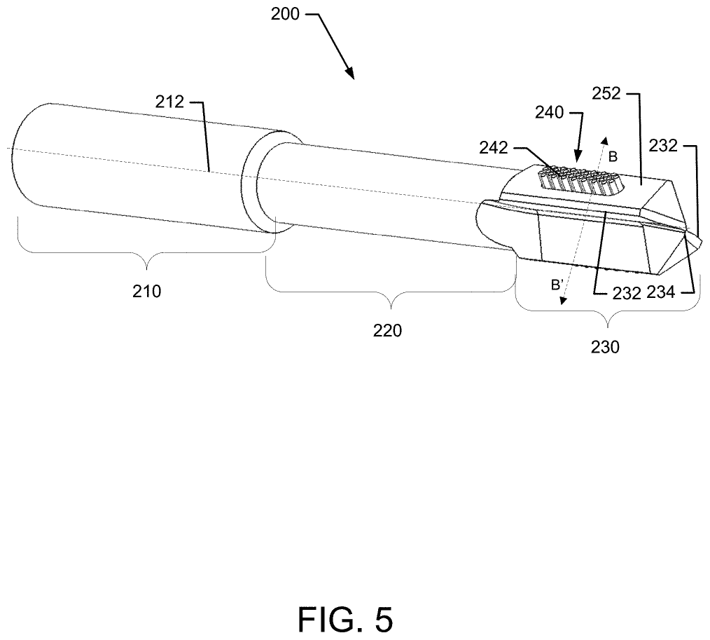

In the example of FIGS. 1-4, the deburring assembly 140 is spaced apart from the cutting point 134 by about 40 mm. Thus, the hole drilled may require a depth of at least 40 mm before any deburring may be accomplished. To eliminate the depth requirement before deburring functions can be performed, it may be possible to form a deburring assembly at the cutting portion instead of in the body portion. FIGS. 5-8 illustrate an example drill bit 200 that is structured to allow deburring to occur at shallower cutting depths.

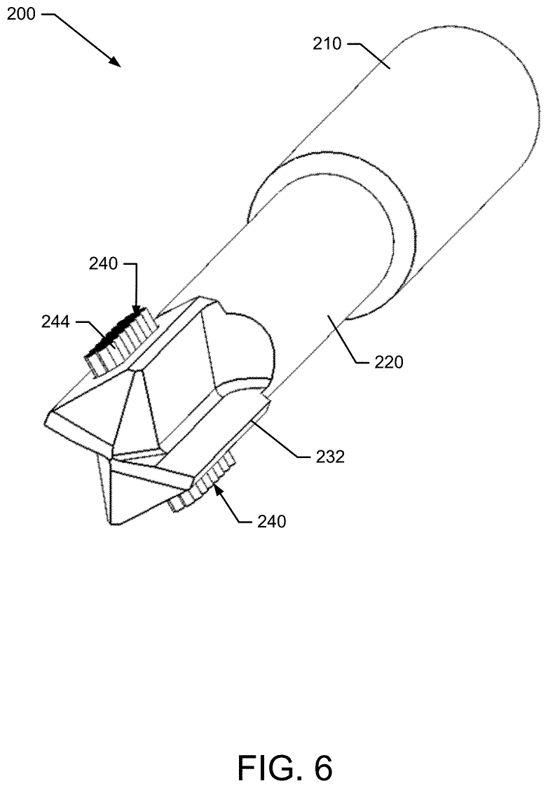

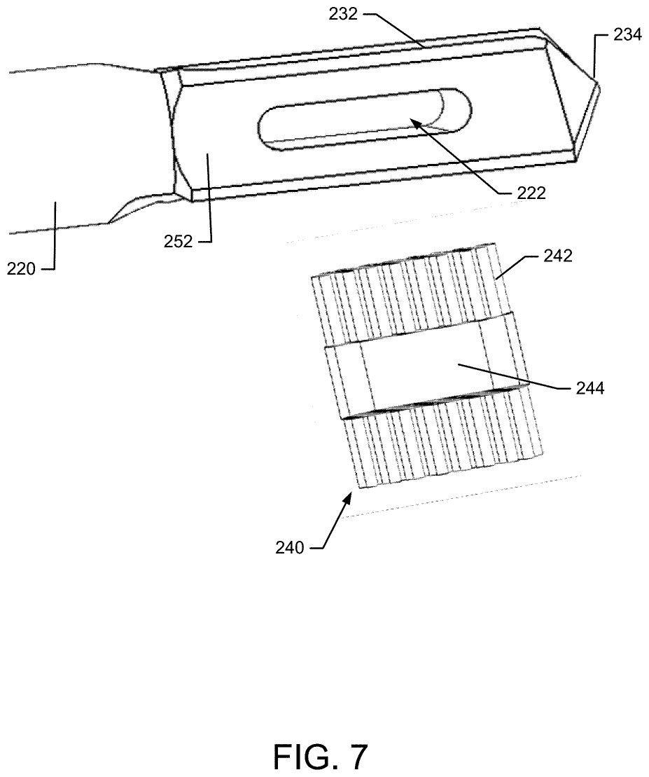

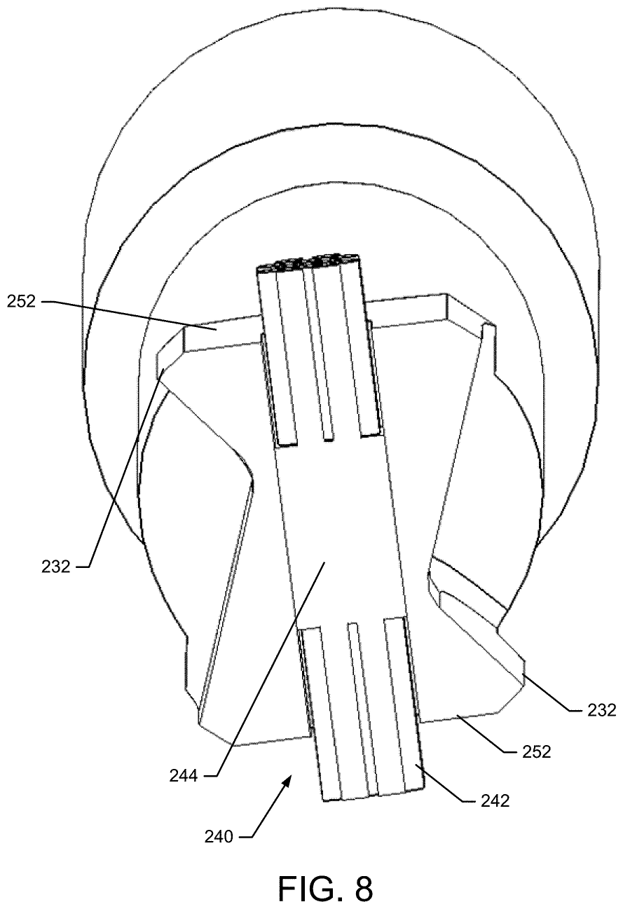

FIG. 5 illustrates a perspective view of the drill bit 200 capable of deburring at a shallow cutting depth according to an example embodiment. As can be seen in FIG. 5, the drill bit 200 includes a shank 210 at a drive end thereof, a body portion 220 extending away from the shank 210, and a cutting portion 230 at a cutting end opposite the drive end. FIG. 6 shows a perspective view of the cutting portion 230 according to an example embodiment showing a deburring assembly 240 in the cutting portion 230 of the drill bit 200. Meanwhile, FIG. 7 illustrates the deburring assembly 240 removed from the cutting portion and FIG. 8 illustrates a cross section view through the deburring assembly 240 taken along line B-B′ of FIG. 5.

Referring now to FIGS. 5-8, the drill bit 200 may include a slot 222 formed in the cutting portion 230 (and not in the body portion 220). The slot 222 may be similar in shape and size to that described above, and may be scaled to the size of the drill bit 200, and moved to the different location. As such, the slot 222 may extend entirely through the body portion 220 in a direction substantially perpendicular to an axis 212 of the drill bit 200. As noted above, a length of the slot 222 (i.e., in a direction parallel to the axis 212 of the drill bit 200) may be substantially larger than a width of the slot 222 (e.g., about 5 times greater).

The deburring assembly 240 may, as noted above, be fit into and extend out of opposing sides of the slot 222. The deburring assembly 240 may be defined by a plurality of brush filaments 242, which may be formed and structured similar to the deburring assembly 140 described above. The brush filaments 242 may be bundled together, and an adhesion agent (e.g., epoxy 244) may be used to retain the brush filaments 242 together as the deburring assembly 240 and bind the brush filaments 242 inside the slot 222 to thereby retain the deburring assembly 240 in the slot 222. As noted above, a length of the brush filaments 242 may be greater than a diameter of the body portion 220. In some cases, the length of the brush filaments 242 may be 3% to 50% larger than the diameter of the body portion 220.

Unlike the example above, where the slot 222 is formed in the body portion 220, the formation of the slot 222 at the cutting portion 230 means there is not necessarily any need to form the recessed portion 150. As such, base surface 252 may extend away from the cutting edge 232 tangential to a circle having a radius defined by the distance from the axis 212 of the drill bit 200 to the base surface 252. The base surfaces 252 on opposite sides (and corresponding to respective cutting edges 232 may be parallel to each other. However, given the slightly larger diameter of the cutting portion 230 relative to the body portion 220 and the placement of the deburring assembly 240 after the cutting edges 232, the base surfaces 252 are positioned to provide sufficient space for the brush filaments 242 to bend over while avoiding any binding of the brush filaments 242 in the hole being drilled.

In the pictured example, the brush filaments 242 extend normal (or perpendicular) to the base surface 252. However, as noted above, the brush filaments 242 may alternatively extend at an angle other than 90 degrees from the base surface 252. In the example of FIGS. 5-8, the brush filaments 242 are centrally located both lengthwise and widthwise on the base surface 252. In other words, equal amounts of the base surface 252 are provided on each opposing side of the slot 222, or the slot 222 is equidistantly spaced apart from opposing edges (lateral and longitudinal) of the base surface 252. However, the amount of spacing may be varied in other examples. The cutting portion 230 in this example also includes multiple (i.e., at least two) cutting edges 232 and a cutting point 234. Although the cutting edges 232 of this example also extend substantially linearly along a line that is parallel to the axis 212 of the drill bit 100, other arrangements are also possible. In this regard, for example, the cutting edges 232 may be curved or even helical in alternative embodiments.

As can be appreciated from the descriptions above, the cutting point 234 may be engaged with a surface or workpiece that is to have a hole bored or drilled therein, and the drill bit 200 may be powered to transmit rotational forces to the drill bit 200. The cutting point 234 and the cutting edges 232 may then combine to bore a cylindrically shaped hole in the surface or workpiece. In some examples, the cutting edges 232 may have a length of about 13 mm, and may define a slightly larger diameter (between cutting edges 232 on opposing sides of the drill bit 200) than the diameter of the body portion 220. For example, if the body portion 220 has a diameter of about 12 mm, then the diameter defined between the cutting edges 232 may be about 13 mm in some embodiments. The deburring assembly 240 is located in the cutting portion 230 so that while the cutting portion 230 cuts a bore hole that extends into the workpiece or surface, deburring can occur even before the body portion 220 enters the hole. Thus, there is no need to have a hole depth that is deeper than the length of the cutting edges 232 in order to receive the benefits provided by the deburring assembly 240. When the deburring assembly 240 reaches the entrance (and any applicable exit encountered as well) of the hole being drilled, the brush filaments 242 will operate abrasively on the entrance and will deburr the entrance (and exit, if applicable) concurrent with continued cutting of the cutting edges 232.

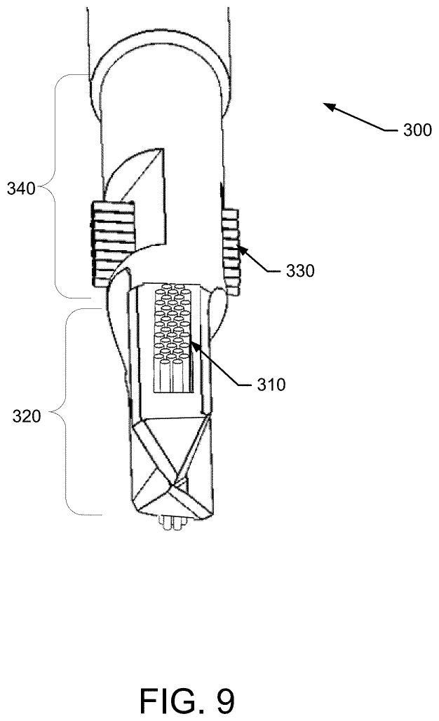

Although the examples above provide two different possibilities for location of a deburring assembly, it may also be possible to combine both options into one embodiment. In this regard, FIG. 9 illustrates an example in which a drill bit 300 has a first deburring assembly 310 is provided in a cutting portion 320 of the drill bit 300, and a second deburring assembly 330 provided in a body portion 340 of the drill bit 300. The first deburring assembly 310 may be similar in structure to the deburring assembly 240 described above in reference to FIGS. 5-8. The second deburring assembly 330 may be similar in structure to the deburring assembly 140 described above in reference to FIGS. 1-4.

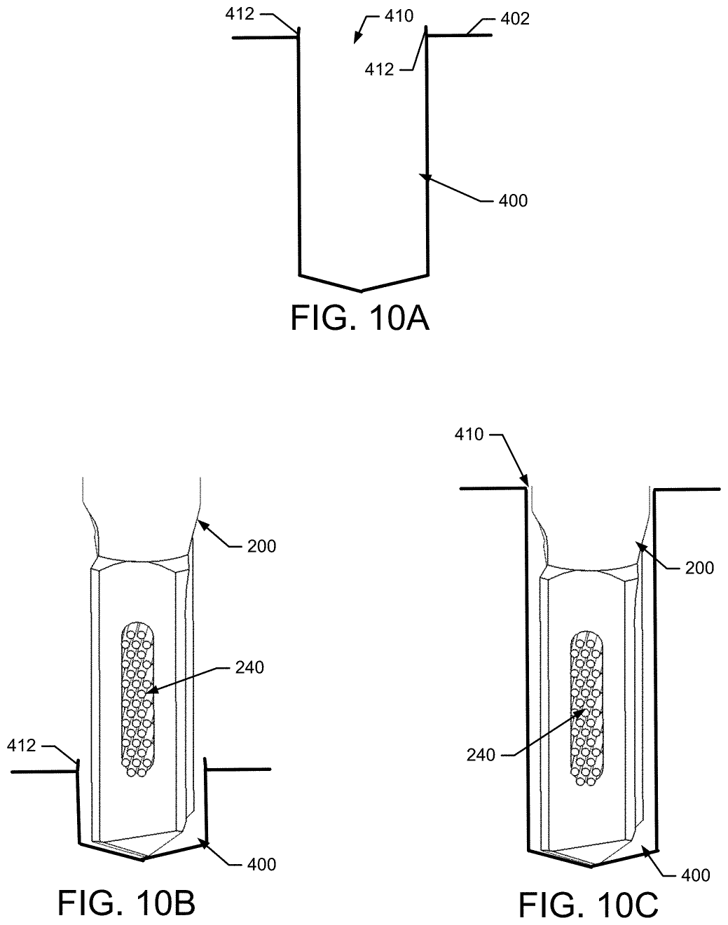

FIG. 10, which is defined by FIGS. 10A, 10B and 10C, illustrates deburring in accordance with an example embodiment. In this regard, FIG. 10A illustrates a cross section view of a hole 400 (e.g., a bore hole or drill hole) formed in a workpiece or surface 402 created by a drill prior to (or without) employing an example embodiment. In this regard, an entrance 410 of the hole 400 includes a burr 412 that extends around the periphery of the entrance 410. FIG. 10B illustrates the hole 400 in the process of being formed with the drill bit 200 described above. In this regard, the hole 400 is being formed, and the burr 412 has likewise also formed. At the point in time shown in FIG. 10B, the deburring assembly 240 is just about to reach the burr 412. Responsive to continued drilling and rotation of the drill bit 200, the deburring assembly 240 may remove the burr 412 from the entrance 410 by abrasive contact therewith, and may become fully inserted into the hole 400 as shown in FIG. 10C. To the extent the hole 400 was a through-hole extending entirely through the material on which the surface 402 is formed (and therefore through to an opposite surface), any burr on the opposite surface could also be removed by the deburring assembly 240. Thus, the user does not need to be concerned with controlling the depth of the drill bit 200 or with separate operation of a tool specialized for burr removal. Instead, the drill bit 200 (or drill bit 100 or 300) is enabled to be fully inserted into the hole to provide two way deburring at any depth that is reachable by the deburring assembly 240.

Accordingly, a cutting tool of an example embodiment may include a shank having a drive end for interfacing with a powered driver, a body portion extending operably coupled to and extending away from the shank, a cutting portion extending from the body portion and sharing an axis with the shank and the body portion, the cutting portion including a plurality of cutting edges, and a deburring assembly operably coupled to the cutting portion or the body portion. The deburring assembly may be configured to be fully insertable into a hole cut by the cutting tool.

In some embodiments, the cutting tool (e.g., drill bit) may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the deburring assembly may be removable and replaceable. In some cases, the deburring assembly may include a plurality of brush filaments extending out of opposite sides of the body portion. In an example embodiment, the body portion may include a slot forming a channel that extends through the body portion substantially perpendicular to the axis, and the brush filaments may be bundled together to extend substantially perpendicular to the axis and extend out of the slot on each of the opposite sides of the body portion. In some cases, the body portion may include a recessed portion having a base surface extending tangential to a circle having a radius defined by a distance from the axis to the base surface. In an example embodiment, the brush filaments may extend perpendicular to the base surface, or may extend at an acute angle relative to the base surface. In some cases, the cutting portion may include a slot forming a channel that extends through the cutting portion substantially perpendicular to the axis. The brush filaments may be bundled together to extend substantially perpendicular to the axis and extend out of the slot on each of the opposite sides of the cutting portion. In an example embodiment, the cutting portion may include a base surface extending tangential to a circle having a radius defined by a distance from the axis to the base surface. In some cases, the brush filaments may extend perpendicular to the base surface. In an example embodiment, the brush filaments may extend at an acute angle relative to the base surface. In some cases, a length of the brush filaments may be between about 3% and 50% larger than a diameter of the body portion. In an example embodiment, the brush filaments may include a plastic material impregnated with abrasive material. In some cases, the abrasive material may include aluminum oxide. In an example embodiment, the brush filaments may be retained in a bundle by epoxy, the epoxy retains the brush filaments in a slot forming a channel that extends through the body portion or the cutting portion substantially perpendicular to the axis. In some cases, a length of the slot is about five times longer than a width of the slot.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A cutting tool comprising:
a shank having a drive end for interfacing with a powered driver;
a body portion extending operably coupled to and extending away from the shank;
a cutting portion extending from the body portion and sharing an axis with the shank and the body portion, the cutting portion including a plurality of cutting edges; and
a deburring assembly operably coupled to the cutting portion or the body portion,
wherein the deburring assembly is configured to be fully insertable into a hole cut by the cutting tool.

2. The cutting tool of claim 1, wherein the deburring assembly is removable and replaceable.

3. The cutting tool of claim 1, wherein the deburring assembly comprises a plurality of brush filaments extending out of opposite sides of the body portion.

4. The cutting tool of claim 3, wherein the body portion comprises a slot forming a channel that extends through the body portion substantially perpendicular to the axis, and
wherein the brush filaments are bundled together to extend substantially perpendicular to the axis and extend out of the slot on each of the opposite sides of the body portion.

5. The cutting tool of claim 4, wherein the body portion comprises a recessed portion having a base surface extending tangential to a circle having a radius defined by a distance from the axis to the base surface.

6. The cutting tool of claim 5, wherein the brush filaments extend perpendicular to the base surface.

7. The cutting tool of claim 5, wherein the brush filaments extend at an acute angle relative to the base surface.

8. The cutting tool of claim 3, wherein the cutting portion comprises a slot forming a channel that extends through the cutting portion substantially perpendicular to the axis, and
wherein the brush filaments are bundled together to extend substantially perpendicular to the axis and extend out of the slot on each of the opposite sides of the cutting portion.

9. The cutting tool of claim 8, wherein the cutting portion comprises a base surface extending tangential to a circle having a radius defined by a distance from the axis to the base surface.

10. The cutting tool of claim 9, wherein the brush filaments extend perpendicular to the base surface.

11. The cutting tool of claim 9, wherein the brush filaments extend at an acute angle relative to the base surface.

12. The cutting tool of claim 3, wherein a length of the brush filaments is between about 3% and 50% larger than a diameter of the body portion.

13. The cutting tool of claim 3, wherein the brush filaments comprise a plastic material impregnated with abrasive material.

14. The cutting tool of claim 13, wherein the abrasive material comprises aluminum oxide.

15. The cutting tool of claim 3, wherein the brush filaments are retained in a bundle by epoxy, and
wherein the epoxy retains the brush filaments in a slot forming a channel that extends through the body portion or the cutting portion substantially perpendicular to the axis.

16. The cutting tool of claim 15, wherein a length of the slot is about five times longer than a width of the slot.

17. A drill bit comprising:
a shank having a drive end for interfacing with a powered driver;
a body portion extending operably coupled to and extending away from the shank;
a cutting portion extending from the body portion and sharing an axis with the shank and the body portion, the cutting portion including a plurality of cutting edges; and
a deburring assembly disposed in a slot formed in the body portion,
wherein the deburring assembly is removable and replaceable.

18. The drill bit of claim 17, wherein the deburring assembly comprises a plurality of brush filaments extending out of opposite sides of the body portion, and
wherein a length of the brush filaments is between about 3% and 50% larger than a diameter of the body portion.

19. A drill bit comprising:
a shank having a drive end for interfacing with a powered driver;
a body portion extending operably coupled to and extending away from the shank;
a cutting portion extending from the body portion and sharing an axis with the shank and the body portion, the cutting portion including a plurality of cutting edges; and
a deburring assembly disposed in a slot formed in the cutting portion,
wherein the deburring assembly is removable and replaceable.

20. The drill bit of claim 19, wherein the deburring assembly comprises a plurality of brush filaments extending out of opposite sides of the cutting portion, and
wherein a length of the brush filaments is between about 3% and 50% larger than a diameter of the body portion.
